(19) United States
(12) Patent Application Publication
(10) Pub. No.: US 2004/0120637 A1
(43) Pub. Date: Jun. 24, 2004

(54) Multichannel optical switch

(76) Inventors: Serge Valette, Grenoble (FR); Jean-Frederic Clerc, Le Fontanil (FR)

Correspondence Address: Oblon Spivak McClelland, Maier & Neustadt, Fourth Floor, 1755 Jefferson Davis Highway, Arlington, VA, 22202, US

(21) Appl. No.: 10/474,043

(22) PCT Filed: Apr. 19, 2002
(86) PCT No.: PCT/FR02/01346

(30) Foreign Application Priority Data
Apr. 23, 2001 (FR) 01/05429

(51) Int. Cl. G02B 6/35

(52) U.S. Cl. 385/22

(57) ABSTRACT

This invention relates to an optical switch comprising:

a rotor (20), with at least one distribution optical waveguide (30),

a stator, comprising a plurality of optical waveguides (14) with extremities turned towards the rotor, and

electrostatic actuating means (M, F, G) for positioning the rotor in switching positions.

According to the invention, the actuating means comprise a first set of electrodes integral with the stator and a second set of electrodes integral with the rotor and associated with the first set, wherein the electrodes of the first set and of the second set are juxtaposed, respectively, with different pitches for each set.

Application to high bandwidth telecommunications.

### TECHNICAL FIELD

This invention relates to a multichannel optical switch.

By optical switch is meant an electrically operated device capable of selectively connecting one or more optical input channels to one or more optical output channels.

Highly miniaturized optical switches find their place mainly in optical signal processing circuits. Therefore, the invention can be put to profitable use, for example, in the field of telecommunications and, in particular, in that of high bandwidth telecommunications. As a matter of fact, optical switches have characteristics that are advantageous for this field of application. Notable, for example, are the characteristics of low optical loss, good immunity to polarization and to the wavelength of light, a low control power and a response time on the order of a millisecond.

### STATE OF THE PRIOR ART

A good illustration of the state of the art is provided by document (1), the complete references of which are mentioned at the end of the description.

The switch described in document (1) comprises a flexible girder having one free extremity and one fixed extremity. The girder is also provided with a distribution optical waveguide. One portion of the optical waveguide corresponding to the fixed extremity of the girder receives an incident light to be distributed. The portion of the optical waveguide corresponding to the free extremity of the girder can be selectively aligned with optical output waveguides of the light. The optical output waveguides are generally two in number and the girder can be deflected in order to align the distribution waveguide with one of the two optical output waveguides.

In order to obtain distribution of a luminous signal to a number N of optical output waveguides greater than 2, document (1) primarily proposes to cascade-connect several single switches to two output channels. The cascading is done, however, at the cost of an increase in the overall dimensions of the switching device, and a greater degree of complexity in the distribution diagrams.

One alternative solution might consist of multiplying the number of optical output waveguides associated with the same distribution waveguide. However, the multiplication of the optical output waveguides poses increasing problems in aligning these output waveguides on the distribution waveguide.

Other features of the state of the art are illustrated by documents (2) and (3) the references of which are also specified at the end of the description.

### DISCLOSURE OF THE INVENTION

The purpose of the invention is to propose a multichannel optical switch without the limitations of the previously described switch.

Another purpose of the invention, linked to the preceding one, is to propose a switch such as this which permits the distribution of one or more input channels towards one or more output channels, and which does not require the cascading of a plurality of switches.

Another purpose of the invention is to propose a switch wherein a more precise and reliable alignment is possible between a distribution optical waveguide and input or output optical waveguides.

Another purpose of the invention is to propose a switch which has a lower sensitivity to vibrations and shocks.

Finally, one purpose of the invention is to propose a switch that is economical, simply constructed and reliable, and that may comprise a large number of switching channels.

In order to achieve these purposes, the object of the invention is more precisely an optical switch comprising:

a movable part, referred to as the rotor, with at least one distribution optical waveguide,

a fixed part, referred to as the stator, comprising a plurality of optical waveguides with extremities turned towards the rotor, and

means of positioning the rotor in switching positions, in which one extremity of at least one distribution optical waveguide of the rotor coincides with at least one extremity of an optical waveguide of the stator.

The positioning means may be, for example, electrostatic and/or electromagnetic. More preferably, these means are electrostatic.

According to one particular embodiment of the switch, the positioning means comprise a first set of electrodes integral with the stator and a second set of electrodes integral with the rotor, and associated with the first set, wherein the electrodes of each set are juxtaposed respectively, with different pitches for each set.

Within the framework of the invention, the use of sets of electrodes with different pitches has several advantages. One of the principal advantages is that the assembly of electrodes of the first set and the second set cannot coincide with each other simultaneously. This allows for stable rotor positions. A second advantage is that it becomes possible to carry out a step-by-step control of the electrodes in order to obtain an even shifting from an idle position to a given stable switching position.

According to one particular feature of the invention, at least one pair of electrodes, comprising respectively one electrode of the first set and one electrode of the second set, can be associated with each switching position, so that the electrodes of said pair are substantially stacked when the rotor occupies a corresponding switching position.

A “switching position” designates a position in which at least one distribution optical waveguide of the rotor is aligned with at least one fixed optical waveguide of the stator.

The position in which the polarized electrodes of one or more pairs are stacked is actually a substantially stable position and can thus be associated with an optical waveguide of the stator.

Nevertheless, improvements tending to further increase the stability of the switching positions of the rotor are proposed. As a matter of fact, the switch can also be provided with mechanical position-securing means. These means may have substantially two functions which are, on the one hand, to precisely fix the switching position of the rotor and, on the other hand, to secure this position against vibrations and shocks.

According to one first possibility, the position-securing means of the rotor may comprise complementarily shaped elements, integral, respectively, with the rotor and the stator, and arranged as to mutually engage in at least one switching position.

The complementarily shaped elements may be interlocking elements such as a slot associated with a protruding tenon that interlock with each other when a switching position is reached and that are released by the electrostatic forces exerted between the electrodes during a switching change.

According to another possibility, the position-securing means may comprise a brake comprising a girder with one fixed extremity, integral with the rotor, and one free extremity capable of being deflected so as to come into contact with the stator.

A brake is understood to mean any controlled element that promotes the holding of the rotor in a switching position either by complementarily shaped pieces fitting one into the other, or by friction contact.

In one particular embodiment of the switch, the latter may comprise a supply voltage generator and electrode addressing means in order to apply the supply voltages sequentially between the closest pairs of electrodes comprising, respectively, at least one electrode of the first set of electrodes and at least one electrode of the second set, from an idle position of the stator to a selected switching position.

This switching enables an almost continuous shifting of the rotor towards the switching position and makes it possible to reach switching positions distant from the initial idle position. As a matter of fact, electrodes of one pair that might be too distant from one another in the idle position would not allow the use of electrostatic forces sufficient to cause movement of the rotor. By applying the supply voltages to the electrodes in a step-by-step fashion, in a direction moving towards the switching position, a movement of the rotor may occur due to the difference in pitches existing between the electrodes of the first and second sets of electrodes.

The stator and the rotor may be formed either in a single substrate or in separate substrates. The switch, for example, may have a first substrate comprising the rotor, the set of electrodes of the rotor and the optical waveguides of the stator, and a second substrate comprising the set of electrodes of the stator.

According to one variant, the first substrate may comprise the rotor and the set of electrodes of the rotor while a second substrate may comprise the optical waveguides of the stator and the set of electrodes of the stator.

The electrodes of the rotor may be made on one face of the rotor parallel to a plane of rotation, i.e., a main face, or else on a face perpendicular to the plane of rotation, i.e., on a slice of the substrate forming the rotor.

Other characteristics and advantages of the invention will become apparent from the following description, with reference to the figures of the appended drawings. This description is given for purely illustrative and non-limiting purposes.

### BRIEF DESCRIPTION OF THE FIGURES

FIG. 1 is a schematic and simplified representation of an optical switch in accordance with the invention.

FIG. 2 is a schematic and simplified representation of another optical switch in accordance with the invention consisting of a variant of the switch of FIG. 1.

FIG. 3 is a simplified representation of a pair of electrodes and illustrates the parameters governing the use of electrostatic forces between the electrodes.

FIG. 4 is a symbolic representation indicating a relationship between the positions of the electrodes of a stator and a rotor of the optical switch of FIG. 2, as a function of drive voltages.

FIGS. 5A and 5B are schematic representations of a detail of switching position-securing means possibly equipping a switch in accordance with the invention.

FIG. 6 is a schematic representation of a detail of an electrostatically controlled brake designed to equip a switch in accordance with the invention.

FIGS. 7A and 7B are simplified and partial schematic representations of two substrates designed to be assembled together in order to form an optical switch in accordance with the invention.

### DETAILED DESCRIPTION OF MODES OF IMPLEMENTING THE INVENTION

In the following text, identical, similar or equivalent elements of the various figures are marked with the same references so as to avoid repeating their description.

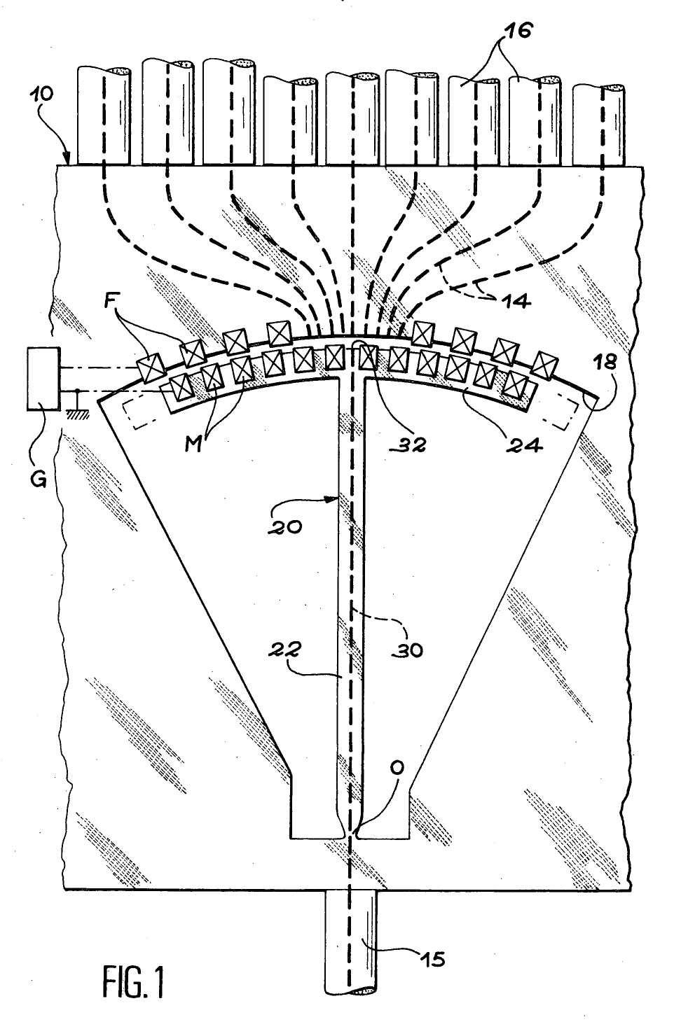

FIG. 1 shows a first embodiment of an optical switch in accordance with the invention. The optical switch includes a stator 10 with a plurality of optical waveguides 14, connected to optical fibers 16, and opening out onto an optical connection edge 18 turned towards a rotor 20. The rotor 20 includes a girder 22 with one fixed extremity connected to the stator 10 and one free extremity 24, referred to as the “head”. For example, the head, together with the body of the girder 22, forms a T. A so-called distribution optical waveguide 30 is formed on the girder 22 and extends as far as the rotor head 24. The optical waveguide 30 has one free extremity 32 turned towards the optical connection edge 18.

The rotor can be moved in an angular rotating movement in the plane of the figure. In the example of the figure, the rotation corresponds to an angular deflection of the girder 22 around an axis of rotation O. The point O coincides substantially with a point of attachment of the fixed extremity of the girder 22 to the stator 10. The movement of the rotor, carried out within a certain angular sector, makes it possible to selectively align the free extremity 32 of the distribution optical waveguide 30 with one of the optical waveguides 14 of the stator opening out onto the connection edge 18.

When the distribution waveguide 30 of the rotor 20 is aligned with one of the optical waveguides 14 of the stator 10, a luminous signal can be transmitted or received by the distribution optical waveguide.

The distribution optical waveguide 30 extends over the stator, beyond the fixed extremity of the girder 22, and is connected to an optical fiber 15. In the following description, this optical fiber 15 and the distribution optical waveguide 30 are considered to be optical input channels while the optical waveguides 14 and the optical fibers 16 situated on the side of the head of the rotor are considered to be optical output channels. This means that an optical signal coming from a single optical input fiber is selectively distributed over a plurality of optical output fibers. Nevertheless, it should be noted that the switch can also be used in the reverse direction, in order to collect, on a single output fiber, signals supplied selectively by a plurality of optical input fibers. Finally, two switches in accordance with FIG. 1, connected head to tail, can selectively connect a plurality of input channels to a plurality of output channels.

On the other hand, the single distribution optical waveguide 30 of FIG. 1 can be replaced by a beam of several distribution optical waveguides, so as to multiply the number of simultaneously connected optical channels in each switching position.

Finally, it can be noted that, for reasons of simplification, only the cores of the optical waveguides are shown in the figures. The cores are indicated by dashed lines. They may possibly be disposed, in a known manner, between optical confinement layers not shown.

The movement of the rotor is ensured, for example, (FIG. 1) by electrostatic actuating means which comprise a set of electrodes M integral with the head 24 of the rotor and a set of electrodes F integral with the stator. The electrodes of the rotor extend from the upper face of the rotor, i.e., the face corresponding to the plane of the figure, onto an edge corresponding to the lateral edge of a plate of material in which the rotor is formed. More precisely, this is the edge perpendicular to the extremity 32 of the distribution waveguide 30.

In the same way, the electrodes of the stator extend at least partially onto the optical connection edge 18, so as to have one face opposite the electrodes of the rotor. In the example of the figure, the sets of electrodes are disposed on both sides of a region comprising the terminals of the optical waveguides 14 of the stator. According to one variant, the optical output fibers may likewise open out onto the optical connection edge between the electrodes.

The application of drive voltages between staggered pairs of electrodes comprising respectively, one or more electrodes of the stator and one or more electrodes of the rotor, makes it possible to exert electrostatic forces on the head 24 of the rotor and to thereby bring about a rotation around point O. In this regard, it can be observed that the girder 22 has a reduced width in the vicinity of point O. This decrease in width makes it possible to reduce the spring constant of the girder 22 in its idle position. The idle position, which is that occupied by the girder 22 in the absence of voltage applied to the electrodes, is also that shown in the figure. In the example of FIG. 1, the idle position also consists of one of the switching positions.

So as not to overload the figures, the addressing tracks of the electrodes are not shown. These are conductive tracks of a very common type, e.g., made of copper. For example, they are formed from a layer of conductive material using lithographic and etching processes, and can be made at the same time as the electrodes. The addressing tracks of the electrodes located on the head of the rotor extend, for example, along the girder 22 until reaching the stator 10. By so doing, and by reason of the narrow width of the girder, it is possible and desirable to bring the entire set of electrodes of the rotor to the same potential. This makes it possible to reduce the number of tracks of the rotor to one. Moreover, in this latter case, a conductive layer of a substrate used for the formation of the rotor can be used as an addressing track. The substrate, for example, is an SOI-type substrate (Silicon on Insulator) or another type having a surface layer that is conductive and insulated by a buried oxide layer.

A drive voltage generator is represented symbolically using the reference G. Its ground terminal is connected to the electrodes of the rotor.

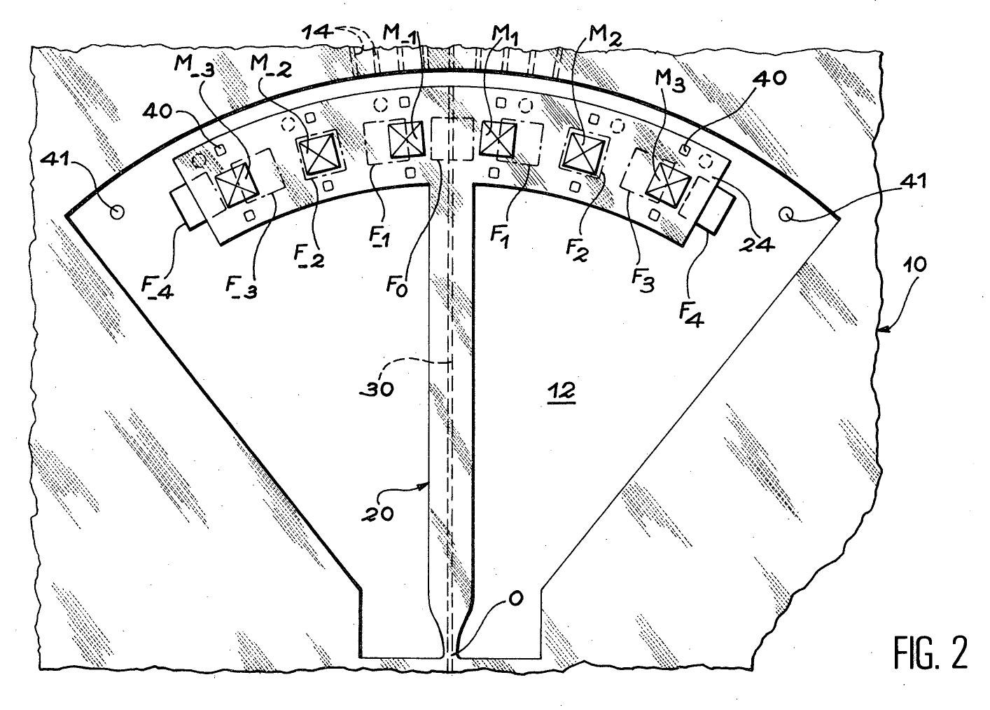

FIG. 2 shows a second possible embodiment of an optical switch in accordance with the invention, which consists of a variant of that shown in FIG. 1. A large number of elements of FIG. 2 are identical to those of FIG. 1 and are therefore not taken up again here. The switch of FIG. 1 is made up of a rotor 20 with a distribution waveguide 30 and a stator 10 which includes the optical output waveguides 14. A supporting substrate 12 situated under the rotor, in the plane of the figure, is integral with the stator 10. The head 24 of the rotor 20, which is wider than that of the rotor of FIG. 1, includes a set of electrodes M₋₃, M₋₂, M₋₁, M₁, M₂, M₃ on its face turned towards the supporting substrate 12. In the figure, the electrodes M are represented by solid lines for reasons of clarity, even though they are situated on the hidden face of the rotor.

The supporting substrate 12 of the stator 10 also has a set of electrodes F₋₄, F₋₃, F₋₂, F₋₁, F₀, F₁, F₂, F₃, F₄ on its face turned towards the rotor 20. This set of electrodes faces that of the rotor and extends within an angular sector designed to be scanned by the rotor in its switching movement. The electrodes F hidden by the rotor are indicated by a dot and dash line and are shown slightly larger than the electrodes M of the rotor in order to better distinguish them.

The reference 40 designates slide bearings integral with the face of the rotor turned towards the supporting substrate 12 of the stator. Their primary function is to establish spacing between the rotor and the stator. The spacing has the dual purpose of reducing friction between the stator and the rotor and of preventing contact between the respective electrodes.

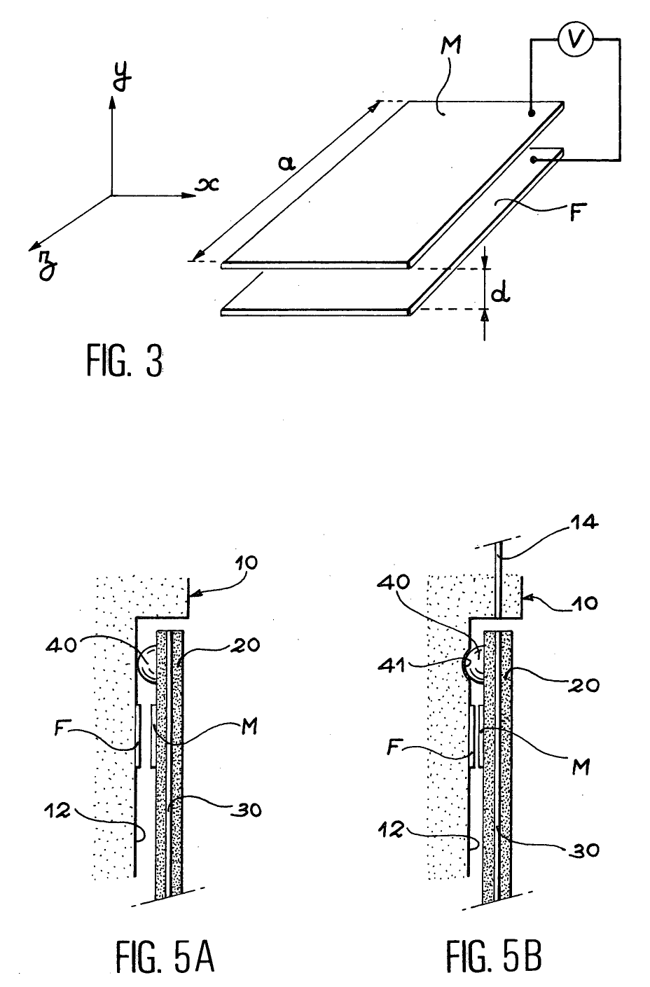

Before examining in greater detail the electrical addressing of the electrodes and their relationship to the position of the rotor, it is useful to briefly recall a few principles governing the electrostatic forces being exerted between two planar and parallel electrodes M and F of a capacitor that are subjected to a voltage V. FIG. 3 can be referred to in this regard, which shows two planar and parallel electrodes having a side with a length a and which are separated from each other by a distance d. The diagram of FIG. 3 is oriented in space by means of a reference marker (x, y, z) indicated on the side of the electrodes.

The electrostatic force F which is exerted between the two electrodes under the effects of a supply voltage V includes two components Fₓ and F_{y} considered in relation to the reference marker indicated above. The expressions for the components Fₓ and F_{y} can be obtained by analytical calculations like those published in document (3) and lead to the approximation formulas published in document (2), while ignoring the edge effects and assuming electrodes of infinite surface. In this case, we have:

Fₓ≅(ε.a.V²)/(2.d) and

F_{y}≅(ε.a.V²)/(2.d²)

In these expressions, ε designates the dielectric constant of the medium separating the electrodes, in this case air.

The force F_{y} is a force tending to draw the electrodes closer together. In the case of the switch of FIG. 2, the effect of this force is limited by the slide bearings 40.

On the other hand, the force Fₓ is a force tending to stack the electrodes. It is advantageously employed within the framework of the invention in order to cause the rotor to move in relation to the stator. It is noted that the force Fₓ tends to maximize the overlapping of the opposing electrodes when their lateral offset remains sufficiently small. Thus, in order to move the rotor by a certain degree, it is preferable to proceed with a sequential addressing of the electrodes of at least one of the sets of electrodes, so as to exert electrostatic forces in degrees on close together or nearly superimposed electrodes, until a sufficient angle of deflection of the girder is obtained, corresponding to a desired switching position.

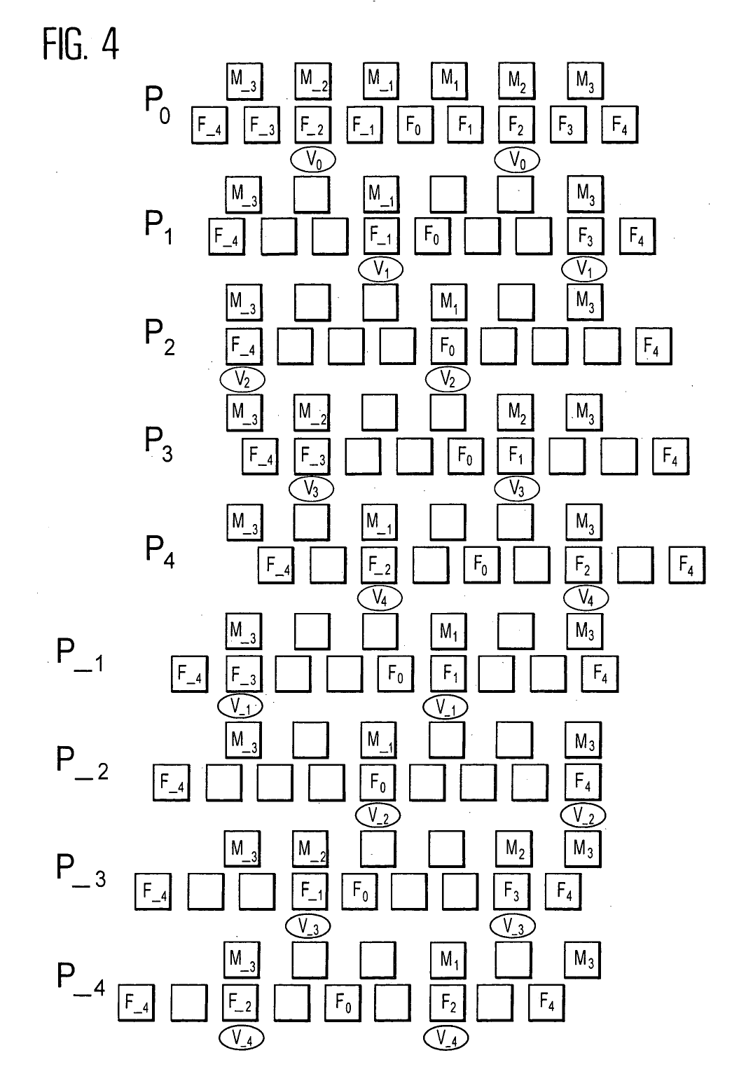

In one particular exemplary embodiment, and for various switching positions of the rotor, FIG. 4 shows the relative arrangement of the electrodes F of the stator and the electrodes M of the rotor of a switch in accordance with FIG. 2. For the sake of simplicity, the electrodes are represented by lines and not by arcs of circles as in FIG. 2. It is assumed that the rotor comprises 6 electrodes having a width L and spaced apart by a distance equal to L. The stator includes 9 electrodes also having a width L and spaced apart by a distance equal to L/2. The electrodes on which a voltage is applied in the switching position are marked by voltage indicators V₋₄ to V₄.

FIG. 4 must be read along with table I below which summarizes the rotor positions, marked from P₋₄ to P₄ and which indicates, for each position, the opposing electrodes and the voltage applied thereto. The position P₀ is the idle position of the rotor shown in FIG. 2.

TABLE I

| POSITION | VOLTAGE | OPPOSING ELECTRODES |
|---|---|---|
| P₀ (central) | V₀ | (M₋₂, F₋₂); (M₂, F₂) |
| P₁ | V₁ | (M₋₁, F₋₁); (M₃, F₃) |
| P₂ | V₂ | (M₋₃, F₋₄); (M₁, F₀) |
| P₃ | V₃ | (M₋₂, F₋₃); (M₂, F₁) |
| P₄ | V₄ | (M₋₁, F₋₂); (M₋₃, F₋₃) |
| P₋₁ | V₋₁ | (M₃, F₄); (M₋₁, F₀) |
| P₋₂ | V₋₂ | (M₂, F₃); (M₋₂, F₋₁) |
| P₋₃ | V₋₃ | (M₋₂, F₋₂); (M₂, F₂) |
| P₋₄ | V₋₄ | (M₁, F₂); (M₋₃, F₋₂) |

The sequential addressing of the electrodes, for example, is designed so as to scan the controls of positions P₁ to P₃ before reaching the position P₄ as the final switching position.

The drive voltages can be lower when the number of electrodes is higher and the pitch between two successive switching positions is smaller.

In other regards, when referring to table I or FIG. 4, it can be noted that the drive voltages for the various positions may be relatively high, e.g., V₀<V₁<V₂<V₃<V₄.

The voltage V₀ corresponding to the idle position might be assumed to be a zero voltage. On the other hand, when the angle of deflection of the girder becomes large, the spring force to be overcome increases. It is possible, and even preferable, to select drive voltages that increase from the idle position to the extreme deflection positions.

In the example considered here, the idle position is the center position of the rotor, with the result being that the voltages V₁ to V₄ can be respectively equal to the voltages V₋₁ to V₋₄.

The switching positions of the rotor are maintained as long as the corresponding drive voltage is applied to the electrodes. Thus, the electrostatic forces make it possible to not only move the rotor towards a given switching position but also, to a certain degree, to maintain this position.

Maintaining the position of the rotor can be improved by equipping the switch with supplementary position maintaining and securing means.

FIGS. 5A and 5B are partial diagrammatic sections of a switch in accordance with the invention, in an area corresponding to the head of a rotor 20. They show mechanical position-securing means.

A boss 40, integral with the rotor, serves as a slide bearing and/or spacer pad between the rotor 20 and the stator. When the rotor is not in a switching position, which corresponds to FIG. 5A, the boss 40 is simply pressed against a slide face of the stator. To this end, the rotor 20 can serve as a return spring. On the other hand, as shown in FIG. 5B, the boss becomes engaged in a notch 41 of the substrate 12 of the rotor, when the distribution waveguide 30 coincides with an output waveguide 14, i.e., when the rotor occupies a switching position.

The boss 40 and the notch 41 provide a locking of the switching position that is sufficiently loose to be overcome by the spring force of the rotor and/or by the electrostatic forces exerted during a change of switching state. However, the lock is sufficiently strong to reduce the sensitivity of the switching state to shocks or external vibrations.

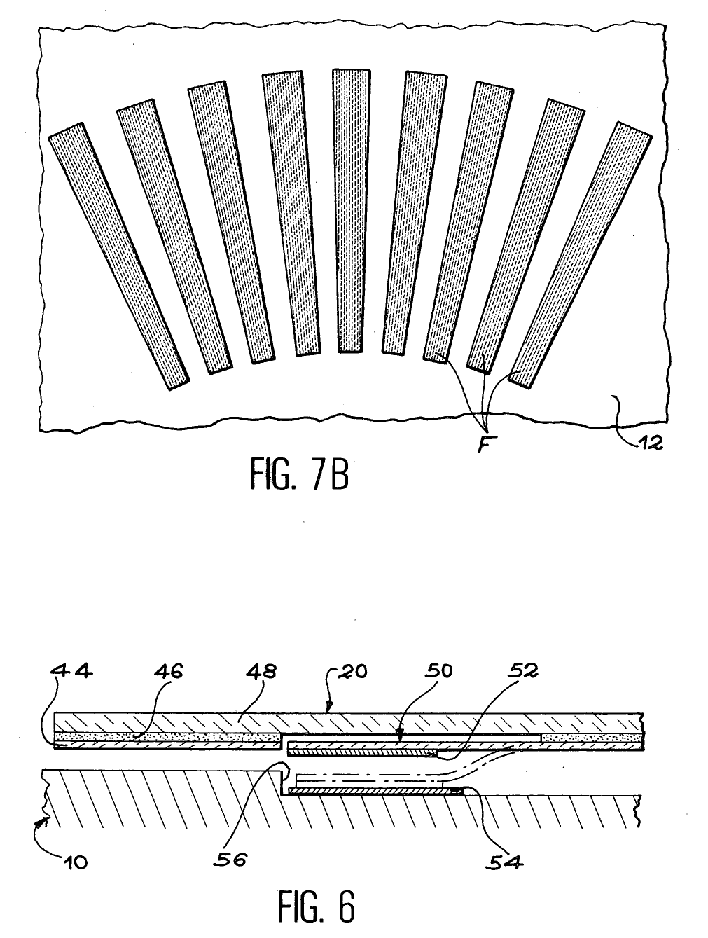

FIG. 6 shows another means of securing the switching positions. It also only shows one portion of a switch rotor and stator.

The rotor is made from a multilayer substrate, e.g., of the SOI-type (Silicon on Insulator), which includes a surface layer 44, separated from a supporting layer 48 by a buried layer 46. A tab 50 is formed in the surface layer 44 turned towards the stator. One extremity of the tab 50 is also freed from the supporting layer 48 by selective and partial etching of the buried layer 46. The distribution optical waveguide is omitted from this figure for the sake of simplicity.

An electrode 52 formed on the tab 50 can cooperate with one or more counter electrodes 54 formed on the substrate. The application of a voltage between the electrode 52 and a counter electrode 54 which faces it makes it possible to deflect the tab 50 into the position indicated by a dashed line. In this position, the tab rubs on the rotor and constitutes a brake. It can also become engaged in a notch 56 of the rotor in order to lock it in a switching position. An insulating layer, not shown in this figure, is disposed on the electrode 52 so as to prevent electrical contact with the electrode 54. When the voltage between the electrodes is eliminated, the tab 50 returns to its initial position indicated by a solid line, and releases the movement of the rotor.

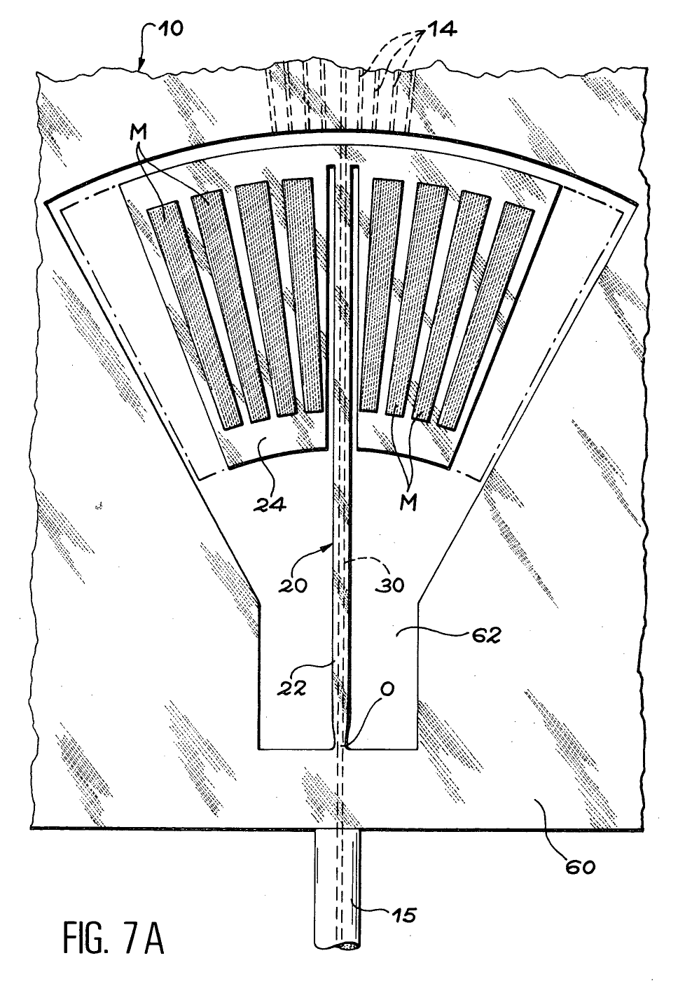

A method will now be described for assembling an optical switch in accordance with the invention. FIG. 7A shows a first substrate plate, e.g., a silicon plate 60 having a thickness on the order of 0.4 mm to 2 mm. The plate is etched according to conventional lithographic and etching techniques in order to make a well 62 therein, and to therein define a rotor 20. The rotor 20 has a girder 22 and a head 24 which extends on both sides of the girder 22, in the form of blades. The same substrate plate 60 forms the rotor 20 and a portion of the stator 10. The stator can receive optical waveguides 14, also formed by techniques known in the field of optical component manufacturing.

Electrodes comparable to those of FIG. 2 are formed on the rotor 20, and more precisely on the blades of the rotor head 24. A more elongated design of the electrodes makes it possible to increase their surface area. The face of the substrate 60, which can be seen in FIG. 7A, is a face that will be turned towards a second substrate with which the first substrate is to be assembled.

The second substrate 12 is partly shown in FIG. 7B. It includes the electrodes F of the stator. It also includes electrode addressing lines (not shown), and may possibly integrate a multiplexer or another electrical switching circuit enabling sequential addressing of the electrodes. The first and the second substrates, for example, are assembled by gluing or molecular adhesion, while turning the electrodes of the rotor towards those of the stator.

### CITED DOCUMENTS

(1) FR-A-2 660 444

(2) “Stepping Electrostatic Microactuator” T. Matysubora et al., 7^{th} International Conference on Solid State Sensors and Actuators.

(3) “Application of Electric Microactuators to Silicon Micromechanics” R. Mahadevan et al., Sensor and Actuators A21-A23 (1990), pp. 219-225.

1. Optical switch comprising:
a movable part (20), referred to as the rotor, with at least one distribution optical waveguide (30),
a fixed part (10), referred to as the stator, comprising a plurality of optical waveguides (14) with extremities turned towards the rotor, and
means of positioning the rotor in switching positions, in which one extremity of at least one distribution optical waveguide (30) of the rotor coincides with at least one extremity of an optical waveguide (14) of the stator,
characterized in that the positioning means comprise a first set of electrodes (F) integral with the stator and a second set of electrodes (M) integral with the rotor and associated with the first set, wherein the electrodes of each set are respectively juxtaposed, with different pitches for each set, and in that the electrodes of the rotor are held by a face of the rotor parallel to a plane of rotation and turned towards a portion of the stator holding the electrodes of the stator.

2. Switch according to claim 1, wherein the rotor is movable in planes which are parallel to the plane rotation.

3. Switch as claimed in claim 1, wherein the positioning means are electrostatic.

4. Switch as claimed in claim 1, wherein at least one pair of electrodes comprising, respectively, one electrode (F) of the stator and one electrode (M) of the rotor is associated with each switching position, with the result being that the electrodes of said pair of electrodes are substantially stacked when the rotor occupies the switching position.

5. Switch as claimed in claim 1, with a first substrate (60) comprising the rotor (20), the set of electrodes (M) of the rotor, and the optical waveguides (14) of the stator, and a second substrate (12) comprising the set of electrodes (F) of the stator.

6. Switch as claimed in claim 1, with a first substrate comprising the rotor and the set of electrodes of the rotor, and a second substrate comprising the optical waveguides of the stator and the set of electrodes of the stator.

7. Switch as claimed in claim 1, further comprising mechanical means (40, 41, 50, 52, 54, 56) of securing the switching positions of the rotor.

8. Switch as claimed in claim 7, wherein the switching position-securing means comprise complementarily shaped elements (40, 41) integral, respectively, with the rotor and the stator and arranged to be engaged in at least one switching position.

9. Switch as claimed in claim 7, wherein the securing means comprise an electrostatically actuated brake integral with the rotor and cooperating with at least one brake electrode (54) integral with the stator.

10. Switch as claimed in claim 9, wherein the brake comprises a tab (50) with one fixed extremity integral with the rotor and one free extremity able to be deflected in order to come into contact with the stator.

11. Switch as claimed in claim 1, comprising a drive voltage generator (G) and electrode addressing means in order to apply the drive voltages sequentially between close together but staggered electrodes comprising, respectively, at least one electrode of the stator and at least one electrode of the rotor, from an idle position of the rotor to a selected switching position.

12. Switch as claimed in claim 11, wherein a ground terminal of the drive voltage generator is connected to the set of electrodes of the rotor.
